(19) United States
(12) Patent Application Publication
(10) Pub. No.: US 2006/0196968 A1
(43) Pub. Date: Sep. 7, 2006

(54) Controlled formation of vapor and liquid droplet jets from liquids

(76) Inventors: Barry H. Rabin, Idaho Falls, ID (US); Fumitomo Hide, San Jose, CA (US)

Correspondence Address: Sharon R. Kantor;c/o: The Firenza Group Ltd., 65 Panorama Court, Danville, CA, 94506-6154, US

(21) Appl. No.: 11/355,461

(22) Filed: Feb. 16, 2006

Related U.S. Application Data
(60) Provisional application No. 60/654,577, filed on Feb. 17, 2005.

(51) Int. Cl. B05B 1/24

(52) U.S. Cl. 239/136

(57) ABSTRACT

Devices for generating a vapor jet from a source liquid comprise a capillary force vaporizer and a condensation controller. Generally, a capillary force vaporizer comprises a porous vaporizer having capillary-sized pores, an enclosure and a vapor egress orifice. The capillary force vaporizer forms a vapor jet from unpressurized liquid by heating the liquid to vaporization in a substantially confined volume. Vapor output from the liquid vaporization section enters the condensation controller, which may be configured to prevent the condensation of vapor or promote the controlled formation of fine liquid droplets, which are generally less than about 100 μm diameter. The condensation controller may be maintained at a predetermined temperature. Alternatively, ambient air or other external gases may be introduced into the condensation controller. Various architectures for the vapor condensation controller are disclosed.

### FIELD OF THE INVENTION

The present invention relates to the controlled formation of vapor and liquid droplet jets from liquids.

### DESCRIPTION OF THE RELATED ART

Various methods are known for the formation of vapors from liquids. Of special interest in the present invention is a class of liquid vaporization devices that generate a jet of vapor at pressures higher than the source liquid. Such devices are described in detail in U.S. Pat. No. 6,634,864, issued 19 Feb. 2002; and U.S. Ser. No. 10/691,067, filed 21 Oct. 2003. For ease of understanding, we refer to this class of liquid vaporization devices as capillary force vaporizers or CFVs. CFVs create vapor by vaporizing a liquid in a vaporization member having capillary-sized pores, with the vaporization member being substantially surrounded by a vapor impermeable enclosure with the exception of one or more vapor ejection orifices. The vaporization member is also referred to as a vaporizer. Because of the large volume expansion that accompanies a liquid-gas phase transition, pressure is generated within the vaporizer. This pressure causes the vapor to be ejected at high speed at the vapor ejection orifice(s).

Some earlier generation vaporizer devices were employed in combustion settings. Stoves and lanterns are two representative examples of such combustion appliances. These combustion appliances used an atomizing spray and required exposure of the atomized spray to the heat of the flame to volatilize the fuel. Liquid fuel was injected into a combustor and broken up either pneumatically or mechanically into a spray of fine droplets. Vaporization of the fuel occurred on the surface of the droplets due to absorption of heat from the flame. The diffusion of air to the droplet resulted in ignition of the vaporized gases surrounding individual droplets, referred to as “droplet burning.” Where groups of droplets were ignited, this was referred to as “cloud burning.” Either droplet burning or cloud burning further heats the droplets and releases additional combustible vapors. A flame zone is formed where volatile gases mix with air supplied through the burner. Droplet evaporation and complete burnout of the gases must occur prior to absorption of heat from the flame and subsequent cooling.

In actual operation of prior art vaporizer devices employed in combustion settings, vapor jets occasionally tended to not remain as a vapor, since air was readily entrained and the vapor jets would be cooled rapidly. The result was that burning droplets of fuel tended to become extinguished prior to complete vaporization, leading to the formation of soot particles. Furthermore, droplet and cloud burning occurred near stoichiometric conditions, resulting in high flame temperatures and generation of high levels of NOₓ. It is therefore desirable to deliver liquid fuel as a vapor instead of a spray in combustion settings. More generally, it is also desirable to be able to deliver any liquid as a vapor instead of a spray from a capillary device.

### SUMMARY OF THE INVENTION

A typical capillary force vaporizer 100 is shown in FIGS. 1A and 1B. FIG. 1A shows a perspective view of device 100. Orifice 102, through which a jet of vapor is ejected, is located at the top of the device. Liquid is supplied through bottom surface 104. Device 100 is shown in greater detail in FIG. 1B, which corresponds to a cross section along line B-B′ of FIG. 1A. In this case, device 100 essentially consists of optional liquid transport component 106, thermal insulator component 108, vaporizer component 110, and orifice component 112. These components are held together with peripheral seal 116, which forms a seal around the periphery of device 100. Seal 116 is preferably impermeable to vapors and liquids. Optional liquid transport component 106, thermal insulator 108, and vaporizer component 110 are all porous 30 members that are located along the liquid flow path in device 100.

The purpose of optional liquid transport component 106 is to transport liquid upward from liquid supply surface 104, which may be in direct contact with a liquid. An example of a liquid transport component is a porous wick. Generally, the temperature of optional liquid transport component 106 is below the liquid's vaporization temperature, such as ambient temperature. The next component in the liquid flow is thermal insulator component 108, which serves the purposes of transporting liquid upward and resisting heat flow downward. In some cases, optional liquid transport component 106 is eliminated and thermal insulator component 108 is brought directly into contact with the liquid. Therefore, the bottom side of thermal insulator component 108 must be below the liquid's vaporization temperature. On the other hand, the top side of thermal insulator component 108 is in contact with vaporization component or vaporizer 110, where liquid vaporization occurs. Vapor ejection from the device is controlled by orifice component 112, which collects the vapor stream. Orifice component 112 has at least one orifice 102 for ejection of vapor at a substantial speed. In device 100, it is convenient to place a heater element in thermal communication with orifice component 112. An electrical resistance heater is one example of a suitable heater element. Heat is transmitted through orifice component 112 towards vaporizer 110. In a typical capillary force vaporizer, the pressure of the vapor as it emerges from orifice 112 is several kPa. As the vapor travels through the ambient, the pressure is greatly reduced. This is different from prior art capillary vaporizers that do not generate significant pressure.

The speed of exit of the vapor through orifice 102 is dictated by the pressure generated in the device. A high pressure can be generated by applying heat and vaporizing the liquid; however, the pressure cannot exceed the capillary pressure of the liquid feed. If the pressure exceeded the capillary pressure, vapor would escape through vaporizer 110. During operation of the device, a vapor front is established in vaporizer 110. The vapor front is the boundary between a liquid-filled region and a gas-filled region, where the liquid-filled region is closer to the thermal insulation component and the gas-filled region is closer to the orifice component. Since vaporizer 110 has capillary-sized pores, a capillary pressure arises in the liquid-filled region. The capillary pressure prevents the incursion of vapor into the liquid supply.

FIG. 2 is a schematic cross sectional view of capillary force vaporizer 200. One difference of device 200 from device 100 is that heater element 222 is positioned directly in thermal contact with vaporizer 210. This structure may reduce response time and power requirements when heater 222 is initially engaged. Device 200 has a stacked cylindrical geometry similar to device 100 of FIGS. 1A and 1B. Device 200 comprises optional liquid transport component 206, thermal insulation component 208, vaporization component 210, and orifice component 212. Orifice component 212 has at least one orifice 202 for ejection of vapor at a substantial speed. These components are bound at their periphery by peripheral seal 216. Liquid is supplied to the bottom surface 204 of liquid transport component 206. It is also possible to eliminate liquid transport component 206. In that case, the bottom of thermal insulation component 208 is the liquid feed surface. Heater element 222 is situated in close thermal contact with vaporizer 210 and positioned so that substantially the entire area of vaporizer 210 is heated when heater 222 is ON.

FIG. 3 is a schematic cross sectional view of a capillary force vaporizer 300. Device 300 is similar to device 200 of FIG. 2. An important difference is that vaporization component 310 also functions as an electric resistance heater. This may be accomplished, for example, by fabricating the vaporization component from an electrically conducting or semiconducting material. Therefore, the manufacturing process may be simplified compared to device 200. Device 300 also comprises optional liquid transport component 306, thermal insulation component 308, vaporization component 310, orifice component 312 having at least one vapor ejection orifice 302, and peripheral seal 316.

Other structures for capillary force vaporizers are also possible. Regardless of the detailed device structure, however, capillary force vaporizers generate a high speed jet of vapor from a source liquid. It is believed that the speed may be as high as the speed of sound. This means that the vapor readily entrains the surrounding air and helps to create a lean fuel vapor-air mixture that is suitable for combustion appliances. The mixing length is the distance that a vapor jet must travel in order to be sufficiently mixed with the surrounding air. Therefore, in a combustion appliance, the flame holder and the capillary force vaporizer should be separated by the mixing distance.

The mixing distance depends on the speed of the vapor jet, which in turn depends on the pressure generated in the capillary force vaporizer and the orifice dimensions. The pressure may be lowered, for example, by increasing the area of the orifice(s). It should be noted that the vapor jet does not necessarily remain a vapor since it readily entrains air and cools rapidly. Therefore, there is a problem in that although the capillary force vaporizer generates a vapor jet and the jet readily entrains air, the cooling effect from mixing with ambient air may cause the vapor to rapidly condense into liquid droplets. Therefore, in some cases the vapor from a capillary force vaporizer may condense into liquid droplets before reaching the burner. In such cases, the burner may emit high levels of soot or NOₓ.

### BRIEF DESCRIPTION OF THE FIGURES

FIG. 1A is a perspective view of a first capillary force vaporizer device.

FIG. 1B is a cross sectional side view of the capillary force vaporizer device of FIG. 1A.

FIG. 2 is a cross sectional side view of a second capillary force vaporizer device.

FIG. 3 is a cross sectional side view of a third capillary force vaporizer device.

FIG. 4 is a simplified perspective view of a device in accordance with a first preferred embodiment of the present invention.

FIG. 5 is a cross sectional side view of a device in accordance with a second preferred embodiment of the present invention.

FIG. 6 is a cross sectional side view of a device in accordance with a third preferred embodiment of the present invention.

FIG. 7 is a cross sectional side view of a device in accordance with a fourth preferred embodiment of the present invention.

FIG. 8 is a cross sectional side view of a device in accordance with a fifth preferred embodiment of the present invention.

FIG. 9 is a cross sectional side view of a device in accordance with a sixth preferred embodiment of the present invention.

FIG. 10 is a cross sectional side view of a device in accordance with a seventh preferred embodiment of the present invention.

FIG. 11 is a simplified schematic view of a device in accordance with an eighth preferred embodiment of the present invention.

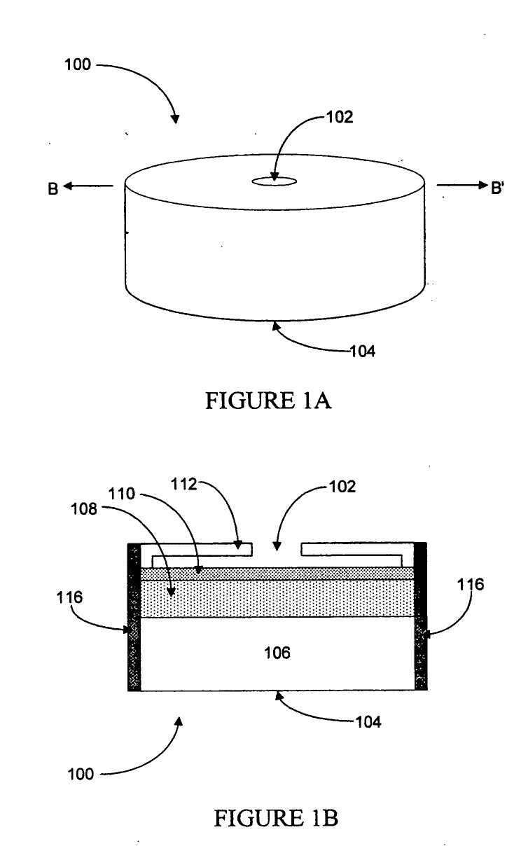

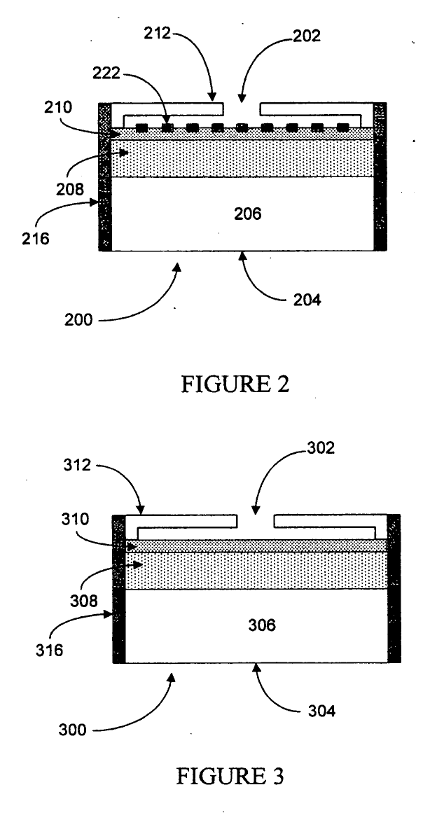

### DETAILED DESCRIPTION OF THE INVENTION

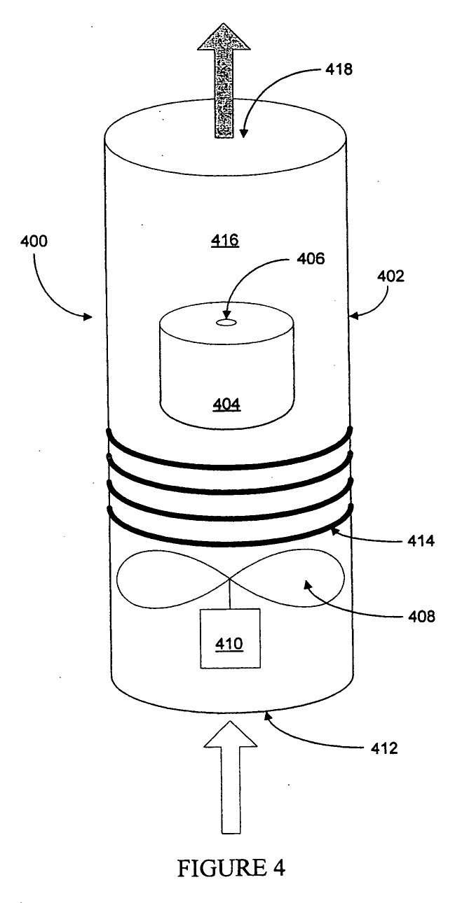

FIG. 4 is a simplified schematic diagram of device 400 in accordance with a first embodiment of the present invention. In this device, the vapor jet output from a CFV is contacted with a gas stream of a known temperature to prevent the condensation of vapor or control the condensation of the vapor to a range of liquid droplet diameters. Device 400 comprises conduit 402, wherein capillary force vaporizer (CFV) 404 is positioned. A liquid is supplied to capillary force vaporizer 404 from a liquid supply source (not shown). The liquid source may be a liquid tank or a pipe or tube that carries the liquid. Attached to or integrated into CFV 404 is a heater, which supplies heat for vaporization of the liquid. Under suitable conditions, a vapor jet emerges from orifice 406. The device is also equipped with optional fan 408 and motor 410 for said fan. Optional fan 408 pushes air from conduit inlet 412 towards conduit exit 418.

Fan 408 can be used to make the appearance of the vapor jet more uniform or pleasing to the eye. For instance, when the source of power to the CFV is turned off, there may be a lag time before vapor stops emanating from the CFV completely. During this lag time, there may be some latent heat to vaporize only a portion of the supply liquid. This latent heat is insufficient to permit the CFV to vaporize the liquid with a vigorous plume. Instead, during this period of so-called secondary vaporization, the latent heat is insufficient to cause the CFV to fully vaporize the supply liquid, and a non-vigorous plume results. Alternately, the secondary vaporization might make it appear as if the CFV were spurting random mixtures of vapor and condensed droplets of liquid. This less vigorous plume might also have an appearance that can be characterized as a swirling column of smoke or a trailing cloud of incense, for example. According to one embodiment of the present invention, therefore, optional fan 408 may be used to modify the appearance of the plume or vapor jet as it is emitted from the CFV, by quickly dispersing or dissipating any secondary vaporization. According to a preferred embodiment of the invention, fan 408 is located in close proximity to CFV 404.

In a preferred embodiment, element 414 is an electric resistance heater. The air is heated by electrical resistance heater 414 before reaching capillary force vaporizer 404. While this particular embodiment uses an electrical resistance heater, alternative heating means may also be used. In particular, another combustion device, such as a lighter, can be used to heat region 414. In the case that the vapor output of device 400 is supplied to a burner, some fraction of the heat output of the burner can be transmitted to region 414. The heated air is entrained by the vapor jet that emerges from orifice 406. The vapor jet and heated air mix thoroughly in mixing region 416. If the ambient air is sufficiently heated it is possible to prevent vapor condensation while the vapor travels in mixing region 416. Alternatively, the temperature of heater 414 may be adjusted to obtain fine liquid droplets having diameters within a desired range. Instead of a heater, element 414 may be a heat exchanger that is cooled by a thermoelectric cooler or other cooling device, or it may comprise any other suitable mechanism familiar to those skilled in the art for controlling the gas temperature within mixing region 416. By controlling the temperature of the ambient air that contacts the vapor jet, condensation of vapor can be controlled.

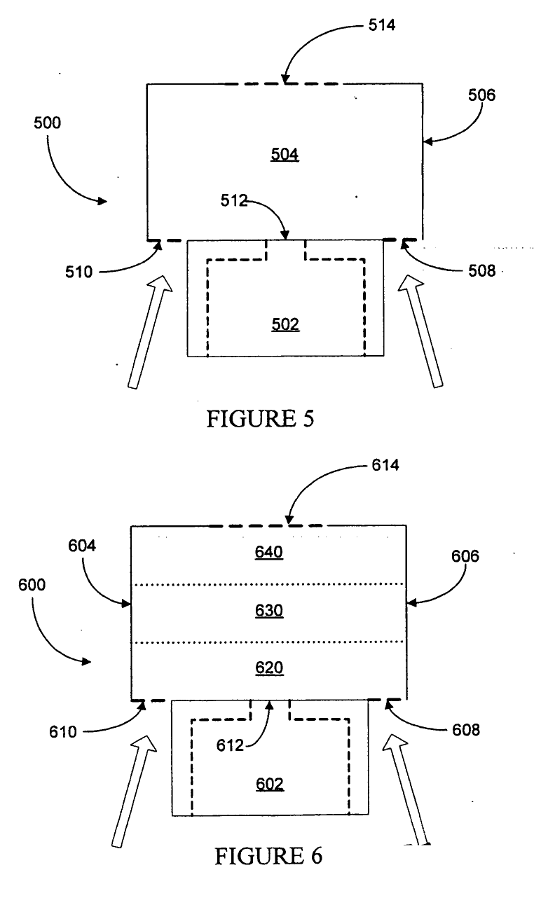

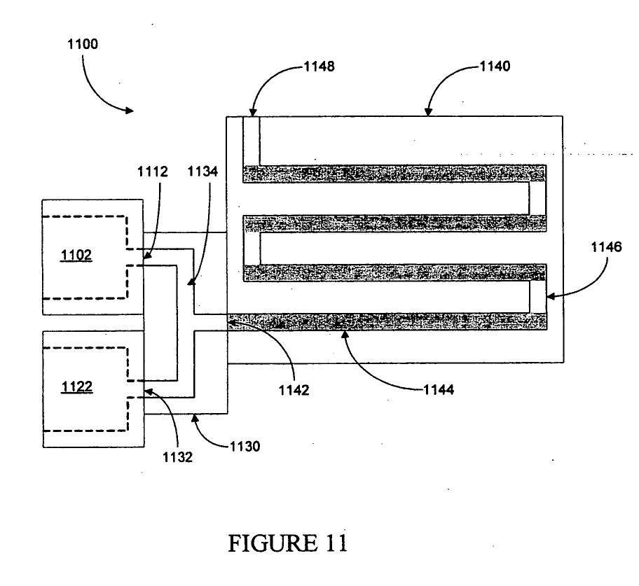

FIG. 5 illustrates a side schematic view of device 500 in accordance with a second embodiment of the present invention. In device 500, the vapor jet output from CFV 502 passes through substantially enclosed chamber 504 that is at a predetermined temperature. A vapor jet is emitted by CFV 502 through orifice 512 into chamber 504. Chamber 504 comprises enclosure 506, gas inlets 508 and 510, orifice 512 and outlet 514. Ambient air enters chamber 504 through gas inlets 508 and 510. Optionally, it is possible to arrange for ambient air or some other external gas to be heated or cooled to a predetermined temperature before entering through gas inlets 508 and 510. For the purpose of the present invention, “ambient air or other gases” refers to an external gas that may be derived from sources other than capillary force vaporizer 502. Therefore, compressed propellant gases fall within the scope of “external gases.” Another possible source of an “external gas” is a second capillary force vaporizer (not shown) that generates a vapor jet, this vapor jet being configured to enter device 500 through gas inlets 508 and 510. A heater or cooler maintains the interior surface of chamber 504 at a desired temperature. Chamber 504 thus functions as a vapor condensation controller in the following manner. The vapor jet can entrain input ambient air or other external gases. Liquid droplets can then be formed by condensation during the residence time of the vapor jet in chamber 504. Alternatively, the temperature of chamber 504 may be sufficiently high such that vapor condensation during residence time of the vapor jet is prevented. Further discussion of vapor condensation control may be found with reference to FIGS. 6 and 11, below.

Chamber 504 may comprise a metallic interior part, an insulating exterior part, and an optional thin film electric resistance heater between the two parts. The surface area of the metallic interior surface can be enhanced by adding a wire mesh or a perforated metal. The metallic interior can be a bilayer structure comprising a contiguous metallic sheet and a reticulated metal such as wire mesh or perforated metal. The enhanced surface area improves the heat exchange between the chamber and the interior gas. For water and other liquids, it may be preferable to use stainless steel for the interior part.

FIG. 6 illustrates a side schematic view of a device 600 in accordance with a third embodiment of the present invention. In this device, the vapor jet output from CFV 602 passes through a plurality of regions with each region having a predetermined temperature. A predetermined temperature is maintained in each region by using a temperature regulator, such as a heater or a cooler (not shown). The combination of a heater and a cooler may also be used. In a typical capillary force vaporizer, the vapor would emerge from CFV 602 at orifice 612 into chamber 604 with a pressure of several kPa. As the vapor travels through condensation control chamber 604, pressure is reduced. That is, pressure of the vapor emitted from CFV 602 tends to fall of in chamber 604 with distance from orifice 602. In general, pressure within chamber 604 can be modified or regulated through selection and variation of various pressure parameters or pressure regulators. These pressure regulators may comprise the size, volume and geometry of the pathway that the emitted vapor from CFV 602 is made to travel within control chamber 604. Additionally, pressure of the vapor in chamber 604 may also be modified or regulated by adjusting the pressure of any other external gases that are allowed to enter chamber 604 through the gas inlets. Accordingly, therefore, both pressure and temperature can be used to control condensation in chamber 604.

A vapor jet is emitted by CFV 602 through orifice 612 into chamber 604. Ambient air enters into chamber 604 through gas inlets 608 and 610. Optionally, it is possible to arrange for ambient air or some other external gas to be heated or cooled to a predetermined temperature before entering through gas inlets 608 and 610. Chamber 604 has enclosure 606 and temperature zones 620, 630, and 640. As will be understood by those knowledgeable in the relevant physical arts, the pressure of the vapor jet emitted from CFV 602 in zone 620 may be higher than the pressure in zone 630, which in turn may be higher than the pressure in zone 640. These pressures and temperatures in combination can be used to control condensation. For example, the temperatures of the foregoing zones may be chosen to effect a decrease in jet temperature and controlled condensation into liquid droplets.

A cooling configuration may be useful when it is desirable to cool the vapor jet over relatively short distances. For example, CPAP, continuous positive airway pressure, devices have been developed to supply humidified air under constant positive pressure to a patient's nasal passages during sleep. This therapy is useful for patients suffering from obstructive sleep apnea, which is characterized by an obstruction of a patient's upper airway during sleep. A conventional CPAP device is generally comprised of a separate ventilator circuit, and compressor powered humidifier unit. The compressor powered humidifier unit is not portable and must be located remotely from the patient, connected to the patient by the long hoses and delivery passageways of the ventilator circuit. A frequent problem with such configurations is a phenomenon known as “rainout”, where water vapor generated by the humidifier condenses inside the tubing and delivery passageways of the ventilator circuit, eventually coalescing into large droplets that stagnate and become a health hazard. In the present invention, however, the device of FIG. 6 can be configured to generate humidified air without the need for a compressor. Moreover, due to its portability, it can be located in the ventilator circuit very close to the patient point of entry. By controlling the cooling rate of the vapor jet, the temperature of the humidified air entering the patient can be reduced to a safe and comfortable level, while condensing the vapor into liquid droplets of an optimum size to avoid the rainout problem mentioned previously.

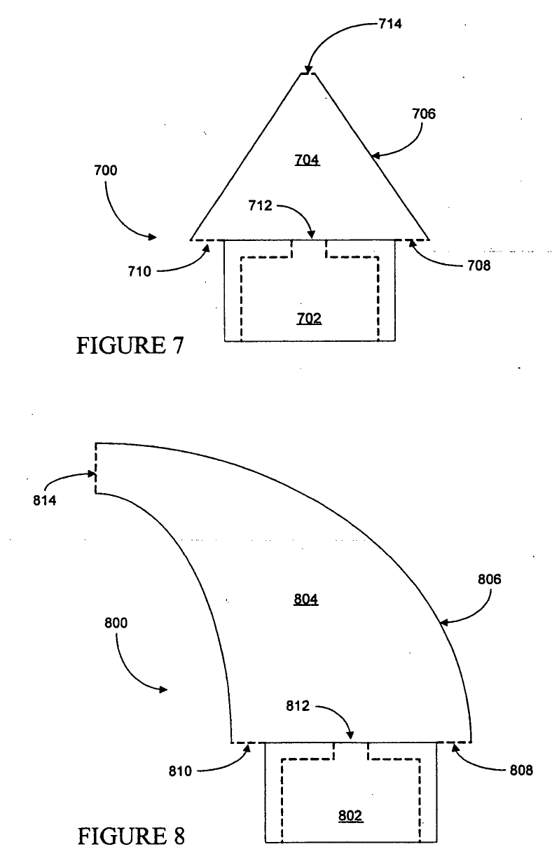

FIG. 7 illustrates a side schematic view of device 700 in accordance with a fourth embodiment of the present invention. In this device, the vapor jet output from CFV 702 passes through a substantially enclosed chamber having a predetermined temperature. This device differs from previously mentioned devices of FIGS. 5 and 6 in that the chamber is shaped to increase the probability that the vapor molecules will collide with the chamber, which promotes nucleation and growth of droplets, thereby providing an additional control means for optimizing droplet size distribution. A vapor jet is emitted by CFV 702 through orifice 712 into chamber 704. Chamber 704 comprises solid enclosure 706, gas inlets 708 and 710, orifice 712 and outlet 714. Ambient air enters into chamber 704 through gas inlets 708 and 710. Note also that chamber outlet 714 is smaller than capillary force vaporizer orifice 712. The geometry of the chamber is configured to increase the speed of the vapor jet. Higher speed results in increased entrainment of ambient air or other external gases. Therefore, the geometry of the chamber is another means for controlling condensation.

FIG. 8 illustrates a side schematic view of device 800 in accordance with a fifth embodiment of the present invention. This embodiment illustrates the possibility of designing devices to meet the requirements of medical inhalation applications application. A medical inhaler is a delivery device that generates droplets of medical formulations for therapy used in the treatment of respiratory ailments. In such treatments, the optimum size distribution for the liquid droplets produced from the medical formulation depends on the specific ailment and prescribed treatment regimen. For example, in the treatment of certain upper respiratory ailments it is desirable for the medical formulation to be deposited in the patient's throat region, in which case the optimum droplet size is in the 10-20 μm range. Alternatively, in cases where it is desirable to deliver a drug or pharmaceutical compound into the patient's blood stream by absorption through deep lung tissues, it is optimal for the droplet size to be in the 3-5 μm range; larger droplets deposit in the throat and never penetrate deep into the lungs whereas smaller droplets are simply exhaled. In either case, droplets not having the optimal size are ineffective and result in the waste of high cost medical formulations. For ease of use, the exit of the inhaler should be in the shape of a mouthpiece.

A conventional inhaler typically uses a compressed propellant, such as a chlorofluorocarbon (CFC) or hydrofluorous alkane (HFA). Usually, these inhalers are operated by operating a switch that releases a short charge of the compressed propellant which contains the medicament through a spray nozzle. A drawback to conventional methods is that they typically produce a wide droplet size distribution, meaning large quantities of medical formulations are not satisfactorily delivered in a form having a high degree of efficacy because of the large fraction of inappropriate liquid droplet sizes. Device 800 of the present invention overcomes this limitation by allowing generation of vapors from medical formulation without the use of compressed propellants, and by controlling the condensation of the liquid droplets affords the ability to optimize the liquid droplet diameters to achieve maximum efficacy in the prescribed treatment of specific ailments. In FIG. 8, chamber 804 is shaped like a mouthpiece and is configured for drug delivery to the human pulmonary system. A vapor jet is emitted by CFV 802 through orifice 812 into chamber 804. Chamber 804 comprises a solid enclosure 806, gas inlets 808 and 810, orifice 812 and outlet 814. In this embodiment, chamber 804, along with gas inlets 808 and 810, may be designed to achieve a fixed optimum droplet size distribution, or alternatively, the size and shape of these features may be designed to be adjustable allowing flexibility to tune the device for different medical uses.

The term “medical formulation” is used to mean a liquid formulation that contains at least one pharmaceutically active compound. A pharmaceutically active compound is a compound that has a therapeutic effect when provided to a mammal, preferably a human mammal. In the present example, a pharmaceutically active compound is delivered to a human pulmonary system via a mouthpiece. It should be noted that pharmaceutically active compounds are not limited to treatments of the pulmonary system. Pharmaceutically active compounds that are conventionally delivered by injection may possibly also be delivered by the devices of the present invention. In addition to the pharmaceutically active compounds, there may be inactive compounds, also called a “carrier”, in the medical formulation. The inactive compounds are preferably in liquid form and do not adversely interact with the pharmaceutically active compound, the patient, the container for the medical formulation, or the delivery device. As mentioned above, a medical formulation as used herein is understood to contemplate a liquid formulation. A liquid formulation is a formulation that is in a flowable form having viscosity, vaporization, and other characteristics such that the formulation can flow through a suitably designed capillary force vaporizer device and be vaporized. Liquid formulations may be solutions such as aqueous solutions, ethanolic solutions, as well as mixtures of the foregoing.

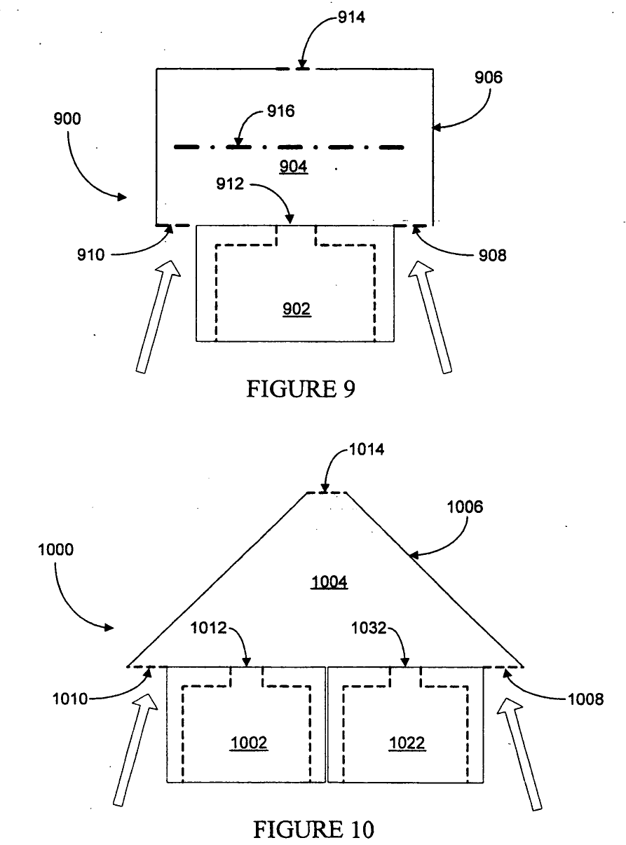

FIG. 9 illustrates a side schematic view of device 900 in accordance with a sixth embodiment of the present invention. This embodiment illustrates an alternative method of controlling the condensation of vapors. A vapor jet is emitted by CFV 902 through orifice 912 into chamber 904. Chamber 904 comprises enclosure 906, gas inlets 908 and 910, orifice 912 and outlet 914. Ambient air or other external gases, with or without prior temperature adjustment, enters into chamber 904 through gas inlets 908 and 910. A reticulated element 916 spans the entire cross section of chamber 904. The reticulated element could preferably be a wire mesh that has high permeability. Since the vapor jet must pass through reticulated element 916, vapor condensation can be controlled or prevented by adjusting its permeability and temperature.

FIG. 10 illustrates a side schematic view of a device 1000 in accordance with a seventh embodiment of the present invention. This device is configured for vaporization of two liquids and mutual entrainment of their respective vapors. Vapor jets are emitted by CFVs 1002 and 1022 through orifices 1012 and 1032, respectively, into chamber 1004. Chamber 1004 comprises enclosure 1006, gas inlets 1008 and 1010, orifices 1012 and 1032 and outlet 1014. Ambient air enters into chamber 1004 through gas inlets 1008 and 1010. Where the liquid being vaporized in CFV 1002 vaporizes a liquid L₁ having boiling temperature T₁, and CFV 1022 vaporizes liquid L₂ having boiling temperature T₂, such that T₁<T₂, then chamber 1004 may be configured to have several temperature profiles, as follows:
1) T₁<T₂<T_{chamber}. This is a configuration to prevent condensation over macroscopic distances. The two vapor jets mix in the chamber.
2) T₁<T_{chamber}<T₂. This configuration induces condensation of L₂ droplets, which subsequently act as nucleation sites for the condensation of L₁.
3) T_{chamber}<T₁<T₂. This configuration induces condensation of both L₁ and L₂.

The concept of vaporization and condensation control of multiple supply fluids is illustrated in FIG. 11. FIG. 11 illustrates an eighth embodiment of the present invention. Device 1100 comprises a hydrocarbon fuel reformer 1140 that supplies hydrogen gas to the anode of a fuel cell (not shown) via exit opening 1148. Capillary force vaporizers 1102 and 1122 are supplied with methanol and water sources, respectively. Vapor jets are emitted at orifices 1112 and 1132 and enter manifold 1130. Manifold 1130 comprises passageway 1134 that combines the methanol and water vapor jets together. Furthermore, manifold 1130 comprises a temperature regulator, such as a heater (not shown), that is configured to increase the temperature of the vapor jet. Since the vaporization temperature of methanol is approximately 64.7° C., the presence of the methanol vapor may cause the water vapor (boiling temperature 100° C.) to condense. It is necessary to prevent the condensation of water and methanol vapors. Temperature regulators, such as heaters, located in manifold 1130 may be used to raise the temperature of the mixture to above the boiling temperature of both liquids to prevent condensation. One reason for this requirement is that a liquid condensate may block the flow passages. Another reason is that catalytic activity is optimal in the gas phase.

The exit of passageway 1134 is connected to fuel reformer inlet 1142. As the mixture flows through the serpentine-configured passages of the fuel reformer, methanol is converted to hydrogen (H₂) and CO₂ gases in the presence of a catalyst. The catalytically active regions 1134 have been denoted by gray and the catalytically inactive regions 1136 have been denoted white. Serpentine-configured flow passages are preferred to maximize the residence time of the methanol and water vapor in the vicinity of the catalyst. A long residence time results in a high conversion ratio of methanol to hydrogen. Furthermore, flow passages with small cross sectional areas are often preferred to obtain high flow velocities. The flow passages of the fuel reformer have a length L, a width or a diameter d, with the ratio L/d >>1. In order to satisfy these requirements, a pressure that is generated at the inlet must be sufficiently high for overcoming the pressure loss in the flow passages. However, a conventional compressor is energetically inefficient and lowers the overall efficiency of the fuel cell system. In this embodiment of the present invention, the capillary force vaporizer eliminates the need for a separate compressor or pump and is therefore a more energy efficient means for generating the vapor for a fuel reformer.

Before starting the operation of the fuel reformer the catalytically active regions 1134 may be at ambient temperature. Therefore, in order to prevent liquid condensation, it may be preferable to apply starter heat, such as by electrical resistance heaters, in the passageways of the fuel reformer immediately before starting the operation of the fuel reformer. It is preferable to include electrical resistance heaters in fuel reformer 1140. FIG. 11 illustrates an example of a vapor condensation controller having a first part and a second part: the first part is a manifold for combining multiple vapor jets; and the second part is a flow passageway for catalytic reactions. The flow passage is preferably configured to be serpentine in form.

Combustion appliances such as stoves and lanterns can be made in accordance with the present invention. The problem to be solved is to prevent the condensation of fuel vapor before it is combusted. This problem may arise when the ambient air is cold or before startup when the burner area is cold. A combustion device may comprise a liquid fuel supply, a capillary force vaporizer, a condensation controller and a burner. The condensation controller either prevents condensation or limits condensation to fine droplets of less than 10 μm (micron) in diameter before the jet reaches the burner. The various condensation control mechanisms that have been described above can be used.

The present invention has been described above in detail with reference to specific embodiments, Figures, and examples. These embodiments, Figures and examples should not be construed as narrowing the scope of the invention, but rather serve as illustrative examples to facilitate an understanding of the invention and ways in which the invention may be practiced, and to further enable those of skill in the pertinent art to practice the invention. It is to be further understood that various modifications and substitutions may be made to the described capillary force vaporizers, devices and systems, as well as to materials, methods of manufacture and use, without departing from the broad scope of the invention contemplated herein. The invention is further illustrated and described in the claims that follow.

We claim:

1. An device for the generation of a jet of liquid droplets from a liquid, comprising:
A liquid supply;
A vaporizer; and
A condensation controller;
wherein
said liquid supply supplies said liquid to said vaporizer;
said vaporizer comprises:
a porous vaporizer having capillary-sized pores;
a vapor egress; and
an enclosure that is configured, in conjunction with said vapor egress, to provide a confined volume in which a pressure is generated from the vaporization of said liquid; and
said condensation controller comprises:
a vapor inlet in fluid communication with said vapor egress;
an outlet; and
a flow passage that connects said vapor inlet and said outlet.

2. The device of claim 1, wherein said condensation controller further comprises:
optionally, a temperature regulator for establishing at least one predetermined temperature within said flow passage;
optionally, a pressure regulator selected from among size, volume, pathway geometry of said flow passage, as well as combinations of the foregoing; and
optionally, an inlet for the introduction of an external gas.

3. The device of claim 1, wherein said liquid supply is a liquid container.

4. The device of claim 1, wherein said liquid supply is a tube or pipe that carries said liquid.

5. The device of claim 1, wherein said vaporizer additionally comprises a heater that is configured to supply vaporization heat to said porous vaporizer.

6. The device of claim 1, wherein said flow passage has walls selected from among electrically conducting walls, thermally conducting walls, as well as combinations of the foregoing.

7. The device of claim 1, wherein said condensation controller additionally comprises a temperature regulator for establishing at least one region of a predetermined temperature range in said flow passage.

8. The device of claim 7, wherein said temperature regulator is selected from among heaters, coolers, heat exchangers, as well as combinations of any of the foregoing.

9. The device of claim 1, wherein:
said flow passage is of a configuration to increase the speed of said vapor jet; further wherein said configuration optionally comprises a serpentine shape; and
said flow passage optionally comprises a reticulated material.

10. The device of claim 1, wherein said flow passage has a length L, a width d, and a ratio L/d such that L/d >>1.

11. The device of claim 1, wherein said flow passage comprises a device selected from among a chemical reactor, a catalytically active region and a fuel reformer; and further wherein said liquid is selected from among a medical formulation, water, as well as combinations of the foregoing.

12. The device of claim 2, wherein said external gas is ambient air.

13. The device of claim 1, further comprising: a blower, a fan as well as a combination of the foregoing.

14. A medical inhaler device comprising the device of claim 1.

15. A humidifier device comprising the device of claim 1.

16. A chemical reactor device comprising the device of claim 1.

17. A combustion appliance comprising the device of claim 1.
